(19) United States
(12) Patent Application Publication
(10) Pub. No.: US 2024/0028376 A1
(43) Pub. Date: Jan. 25, 2024

(54) LOG FORWARDING FOR AN AGENT PLATFORM APPLIANCE AND SOFTWARE-DEFINED DATA CENTERS THAT ARE MANAGED THROUGH THE AGENT PLATFORM APPLIANCE

(71) Applicant: VMWARE, INC., Palo Alto, CA (US)

(72) Inventors: PRATEEK GUPTA, San Francisco, CA (US); PRAVEEN TIRUMANYAM, Bangalore (IN); MATTHEW WILLINGHAM, Orlando, FL (US); LAV JAIN, Battle Ground, IN (US)

(21) Appl. No.: 17/979,890

(22) Filed: Nov. 3, 2022

(30) Foreign Application Priority Data
Jul. 22, 2022 (IN) 202241042186

(51) Int. Cl. G06F 9/455

(52) U.S. Cl. CPC G06F 9/45558; G06F 2009/4557; G06F 2009/45591

(57) ABSTRACT

A method of forwarding logs of a software-defined data center (SDDC) and logs of an agent platform appliance to a cloud platform through the agent platform appliance, the agent platform appliance having deployed thereon a plurality of agents of cloud services that are delivered to the SDDC, includes the steps of: collecting first log data from one or more management appliances of the SDDC; collecting second log data from one or more of the agents of cloud services; acquiring one or more access tokens for communicating with the cloud platform; and transmitting log data generated from the collected first log data and the collected second log data, along with the one or more access tokens, to a log monitoring service running in the cloud platform, wherein the log monitoring service is configured to generate alerts separately for different tenants of the computer system from log data of the different tenants.

### RELATED APPLICATIONS

Benefit is claimed under 35 U.S.C. 119(a)-(d) to Foreign Application Serial No. 202241042186 filed in India entitled “LOG FORWARDING FOR AN AGENT PLATFORM APPLIANCE AND SOFTWARE-DEFINED DATA CENTERS THAT ARE MANAGED THROUGH THE AGENT PLATFORM APPLIANCE”, on Jul. 22, 2022, by VMware, Inc., which is herein incorporated in its entirety by reference for all purposes.

### BACKGROUND

In a software-defined data center (SDDC), virtual infrastructure, which includes virtual machines (VMs) and virtualized storage and networking resources, is provisioned from hardware infrastructure that includes a plurality of host servers, storage devices, and networking devices. The provisioning of the virtual infrastructure is carried out by SDDC management software that is deployed on management appliances, such as a VMware vCenter Server ° appliance and a VMware NSX® appliance, available from VMware, Inc. The SDDC management software communicates with virtualization software (e.g., a hypervisor) installed in the host servers to manage the virtual infrastructure.

It has become common for multiple SDDCs to be deployed across multiple clusters of host servers. Each cluster is a group of host servers that are managed together by the management software to provide cluster-level functions, such as load balancing across the cluster through VM migration between the host servers, distributed power management, dynamic VM placement according to affinity and anti-affinity rules, and high availability. The management software also manages a shared storage device to provision storage resources for the cluster from the shared storage device, and a software-defined network, through which the VMs communicate with each other. For some customers, SDDCs are deployed across different geographical regions, and may even be deployed in a hybrid manner, e.g., on-premise, in a public cloud, and/or as a service.

“SDDCs deployed on-premise” means that the SDDCs are provisioned in a private data center that is controlled by a particular organization. “SDDCs deployed in a public cloud” means that SDDCs of a particular organization are provisioned in a public data center along with SDDCs of other organizations. “SDDCs deployed as a service” means that the SDDCs are provided to the organization as a service on a subscription basis. As a result, the organization does not need to carry out management operations on the SDDC such as configuring, upgrading, and patching, and the availability of the SDDCs is provided according to a service level agreement of the subscription.

With a large number of SDDCs, monitoring and performing operations on the SDDCs through interfaces, e.g., application programming interfaces (APIs), provided by the management software, and managing the lifecycle of the management software, have proven to be challenging. Conventional techniques for managing the SDDCs and the management software of the SDDCs are not practicable when there is a large number of SDDCs, especially when they are spread out across multiple geographical locations and in a hybrid manner.

### SUMMARY

One or more embodiments provide a cloud platform from which various services, referred to herein as “cloud services,” are delivered to SDDCs through agents of the cloud services that are running in an appliance (referred to herein as an “agent platform appliance”). As used herein, an SDDC is a virtual computing environment provisioned from a plurality of host servers, storage devices, and networking devices by management software for the virtual computing environment that communicates with hypervisors running in the host servers. The cloud platform is a computing platform that hosts containers or VMs corresponding to the cloud services that are delivered from the cloud platform. The agent platform appliance is deployed in the same customer environment, e.g., a private data center, as the management appliances of the SDDCs.

In one embodiment, the cloud platform is provisioned in a public cloud, the agent platform appliance is provisioned as a VM in the customer environment, and the two communicate over a public network, such as the Internet. In addition, the agent platform appliance and the management appliances communicate with each other over a private physical network, e.g., a local area network (LAN). Examples of cloud services that are delivered include an SDDC configuration service, an SDDC upgrade service, an SDDC monitoring service, an SDDC inventory service, and a message broker service. Each of these cloud services has a corresponding agent deployed on the agent platform appliance. All communication between the cloud services and the management software of the SDDCs is carried out through the agent platform appliance, for example, through respective agents of the cloud services that are deployed on the agent platform appliance.

One or more embodiments provide a method of forwarding logs of an SDDC and logs of an agent platform appliance to a cloud platform through the agent platform appliance, the agent platform appliance having deployed thereon a plurality of agents of cloud services that are delivered to the SDDC. The method includes the steps of: collecting first log data from one or more management appliances of the SDDC; collecting second log data from one or more of the agents of cloud services; acquiring one or more access tokens for communicating with the cloud platform; and transmitting log data generated from the collected first log data and the collected second log data, along with the one or more access tokens, to a log monitoring service running in the cloud platform. The cloud platform is a multi-tenant cloud platform, and the log monitoring service is configured to generate alerts separately for each of different tenants of the computer system from log data of the different tenants that is forwarded to the log monitoring service and that originates from SDDCs and agent platform appliances of the different tenants

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a block diagram of a computer system in which a first embodiment may be implemented.

FIG. 2A is a system diagram illustrating the updating of endpoints of host servers and components of an SDDC and of agents and a system process of an agent platform appliance, for transmitting log data to, according to the first embodiment.

FIG. 2B is a system diagram illustrating the collecting of log data from the host servers and components of the SDDC and from the agents and system process of the agent platform appliance, according to the first embodiment.

FIG. 2C is a system diagram illustrating the transmitting of log data to a log monitoring service of a cloud platform, according to the first embodiment.

FIG. 3 is a flow diagram of steps performed by agents of the agent platform appliance and an SDDC component to carry out a method of updating an endpoint of the SDDC component, according to the first embodiment.

FIG. 4 is a flow diagram of steps performed by agents of the agent platform appliance and a cloud authentication service of the cloud platform to carry out a method of transmitting log data to a cloud proxy service of the cloud platform, according to the first embodiment.

FIG. 5 is a flow diagram of steps performed by the cloud proxy service and an organization using the log monitoring service of the cloud platform to carry out a method of generating an alert regarding the operation of host servers or a component of an SDDC or the operation of an agent or system process of the agent platform appliance, according to embodiments.

FIG. 6 is a block diagram of a computer system in which a second embodiment may be implemented.

FIG. 7A is a system diagram illustrating the updating of endpoints of host servers and components of an SDDC and of agents and a system process of the agent platform appliance, for transmitting log data to, according to the second embodiment.

FIG. 7B is a system diagram illustrating the collecting of log data from the host servers and components of the SDDC, according to the second embodiment.

FIG. 7C is a system diagram illustrating the collecting of log data from the agents and system process of the agent platform appliance, according to the second embodiment.

FIG. 7D is a system diagram illustrating the transmitting of log data to the log monitoring service of the cloud platform, according to the second embodiment.

FIG. 8 is a flow diagram of steps performed by agents of the agent platform appliance and the cloud authentication service of the cloud platform to carry out a method of acquiring an access token for authenticating with the log monitoring service of the cloud platform, according to the second embodiment.

FIG. 9 is a flow diagram of steps performed by a process of the agent platform appliance to carry out a method of transmitting log data to the cloud proxy service of the cloud platform, according to the second embodiment.

### DETAILED DESCRIPTION

Techniques for forwarding logs of a tenant's SDDCs and logs of an agent platform appliance, are described. According to embodiments, the agent platform appliance is deployed in a customer environment of the tenant, the customer environment including the tenant's SDDCs, which have management software executing therein. The agent platform appliance is connected to the same management network as management appliances on which the management software is deployed. To connect the tenant's SDDCs to cloud services of a cloud platform, agents are deployed on the agent platform appliance. The agents perform various functionalities, including transmitting commands to the management software of the SDDCs, acquiring authentication tokens for authenticating with the management software, and acquiring access tokens for authenticating with the cloud services.

Communications between the agent platform appliance and the cloud platform are authenticated using tokens (hereinafter referred to as “access tokens”). Furthermore, communications between the agent platform appliance and the SDDCs are authenticated using tokens (hereinafter referred to as “authentication tokens”). Through the agent platform appliance, the cloud platform delivers cloud services to the management software. To perform lifecycle management of both the SDDCs and the agent platform appliance from the cloud platform, service logs of the SDDCs and agent platform appliance are collected. The logs contain information about, e.g., usage patterns, activities, and operations of the entities generating the logs.

According to a first embodiment, logs are collected by a plurality of agents deployed on the agent platform appliance, the plurality of agents then transmitting the collected logs to the cloud platform. According to a second embodiment, logs are collected by a process running on the agent platform appliance, the process then transmitting the collected logs to the cloud platform. The content of the logs is referred to herein as log data. According to both embodiments, the log data is embedded with metadata, enabling a centralized log monitoring service running on the cloud platform to determine where log data originated. The log monitoring service is configured to read the embedded log data, to detect patterns that indicate potential issues with the operation of host servers and components of the SDDCs and the operation of agents and system processes of the agent platform appliance, and to generate alerts from the log data in response to detecting such patterns.

The methods by which log data is collected, reported, and analyzed according to embodiments provide a variety of advantages. Firstly, the log data is periodically transmitted from the agent platform appliance to the log monitoring service such that the log monitoring service quickly discovers issues to flag, which may then be remediated. Secondly, the transmission of the log data is automated such that when issues arise, the tenant is not required to manually generate support bundles to upload to the log monitoring service. Thirdly, to reduce network strain between the agent platform appliance and the cloud platform, log data is transmitted to the cloud platform in batches and compressed. These and further aspects of the invention are discussed below with respect to the drawings.

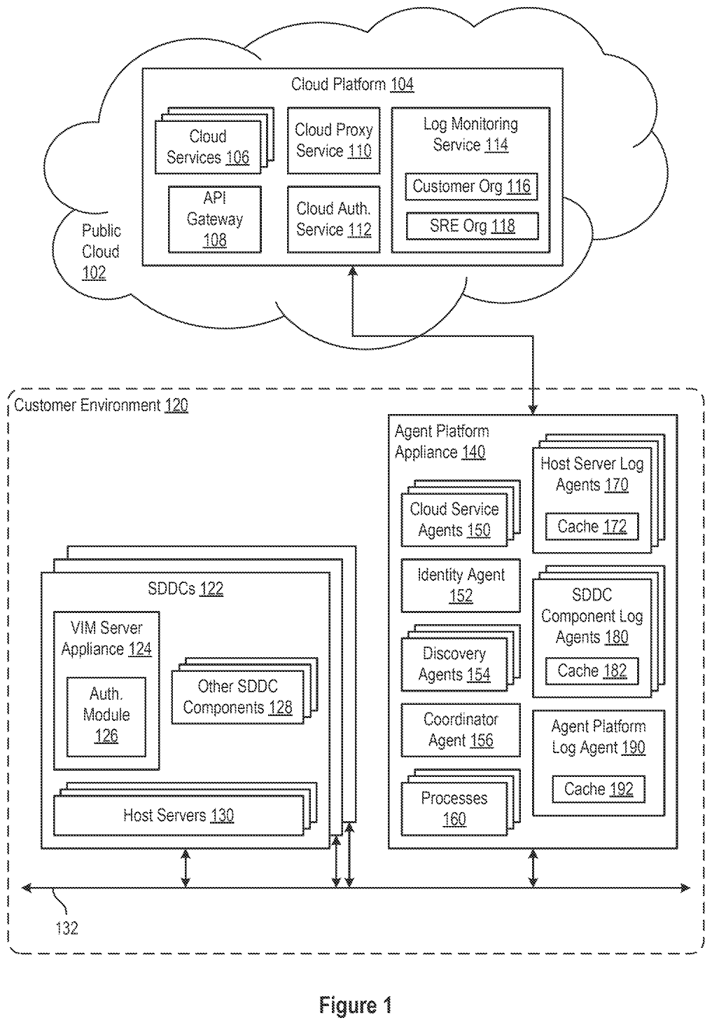

FIG. 1 is a block diagram of a computer system in which a first embodiment may be implemented. The computer system includes a multi-tenant cloud platform 104 deployed in a public cloud 102, and a customer environment 120, in which SDDCs 122 of a particular tenant are deployed. Communications between cloud platform 104 and SDDCs 122 are carried out via an agent platform appliance 140 of customer environment 120. Communications between cloud platform 104 and agent platform appliance 140 are carried out over a public network such as the Internet.

Each of SDDCs 122 includes host servers 130, host servers 130 being constructed on server grade hardware platforms (not shown) such as x86 architecture platforms. Host servers 130 include conventional components of computing devices (not shown), such as one or more central processing units (CPUs), memory such as random-access memory (RAM), local storage such as one or more magnetic drives or solid-state drives (SSDs) and/or a host bus adapter for connection to a storage area network, and one or more network interface cards (NICs). The NIC(s) enable host servers 130 to communicate with each other and with other devices over a management network 132. Host servers 130 include software platforms including hypervisors (not shown), which are virtualization software layers that support VM execution spaces (not shown) within which VMs are concurrently instantiated and executed. Each of SDDCs 122 also includes additional hardware devices (not shown) such as shared storage and networking devices.

Each of SDDCs 122 includes a VIM server appliance 124 and other SDDC components 128, which are management appliances each running various management software. VIM server appliance 124 logically groups host servers 130 into a cluster to perform cluster-level tasks such as provisioning and managing VMs and migrating VMs from one of host servers 130 to another. One example of VIM server appliance 124 is a VMware vCenter Server ° appliance, available from VMware, Inc. Other SDDC components 128 provide other management functionalities such as provisioning virtual networking resources. An example of one of other SDDC components 128 is a VMware NSX® appliance, available from VMware, Inc.

VIM server appliance 124 and other SDDC components 128 communicate via management network 132, and the various management software running thereon are referred to collectively herein as “management software.” Management network 132 is distinguishable from the public network connecting agent platform appliance 140 and cloud platform 104, in that management network 132 is a private network, e.g., a LAN or sub-net, and is partitioned from the public network through a firewall. In some embodiments, each of the SDDC components, including VIM server appliance 124, is a VM instantiated on one or more of host servers 130. In other embodiments, each of the SDDC components is implemented as a physical host server having the conventional hardware platform described above with respect to host servers 130.

VIM server appliance 124 includes an authentication module 126, which authenticates requests for access. When it is able to authenticate such requests, authentication module 126 issues role-based authentication tokens such as Security Assertions Markup Language (SAML) tokens. Each authentication token allows a party possessing the token to access VIM server appliance 124 to perform an operation on VIM server appliance 124 that is associated with the issued token. Other SDDC components 128 similarly each include an authentication module (not shown), which issues role-based authentication tokens for requesting parties. For security purposes, authentication tokens each have a specified time-to-live (TTL), after which the tokens expire.

Cloud platform 104 is provisioned in public cloud 102, and public cloud 102 is operated by a cloud computing service provider, from a plurality of physical host servers (not shown). Cloud platform 104 includes cloud services 106, an API gateway 108, a cloud proxy service 110, a cloud authentication service 112, and a log monitoring service 114. Cloud services 106 include an SDDC configuration service, an SDDC upgrade service, an SDDC monitoring service, and an SDDC inventory service. API gateway 108 provides a method of communicating securely with services of cloud platform 104, as discussed further below.

Log monitoring service 114 is a centralized location for analyzing log data. Log monitoring service 114 includes a plurality of components through which tenants of SDDCs view log data of their respective SDDCs, including a customer organization component 116 for the tenant of SDDCs 122. Log monitoring service 114 also includes a site reliability engineer (SRE) organization component 118 through which an SRE monitoring the SDDCs of tenants views log data. SRE organization 118 reads log data to automatically detect patterns that indicate potential issues for the tenants of SDDCs, including issues arising from SDDCs 122 and agent platform appliance 140, and SRE organization 118 automatically generates alerts from the log data in response to detecting such patterns. An example of log monitoring service 114 is VMware vRealize® Log Insight, available from VMware, Inc. Cloud proxy service 110 receives log data from agent platform appliance 140 via API gateway 108. Cloud proxy service 110 duplicates log data and provides two copies of the log data to log monitoring service 114, one for customer organization 116 and another for SRE organization 118.

Cloud authentication service 112 enables authentication with services of cloud platform 104. To enable such authentication, cloud authentication service 112 issues access tokens such as JavaScript Object Notation (JSON) web tokens (JWTs). Each access token allows a requesting party to interface with services through API gateway 108. It should be noted that although cloud authentication service 112 is illustrated as being within cloud platform 104, cloud authentication service 112 may run on a virtual or physical server that is not part of cloud platform 104. For security purposes, access tokens each have a specified TTL, after which the tokens expire.

Agent platform appliance 140 is, e.g., a physical server, or a VM deployed on a host server similar to host servers 130, the host server including a CPU(s) configured to execute instructions such as executable instructions that perform one or more operations described herein and including memory in which such executable instructions are stored. Agent platform appliance 140 is connected to management network 132 such that agent platform appliance 140 and SDDCs 122 are on the same side of a firewall (not shown) of customer environment 120. As a result, communications between agent platform appliance 140 and SDDCs 122 are secure and protected from attacks originating from outside customer environment 120 such as snooping attacks.

On agent platform appliance 140, various agents are deployed, including cloud service agents 150, an identity agent 152, discovery agents 154, a coordinator agent 156, host server log agents 170, SDDC component log agents 180, and agent platform log agents 190. The agents on agent platform appliance 140 communicate with each other, e.g., through hypertext transfer protocol (HTTP) APIs. The agents on agent platform appliance 140 also communicate with SDDCs 122 and cloud platform 104. Coordinator agent 156 deploys the agents on agent platform appliance 140, managing the lifecycle and orchestration thereof.

Cloud service agents 150, which correspond to cloud services 106, issue commands to the management software of SDDCs 122 and report results of operations to cloud services 106 via APIs of cloud services 106. Cloud service agents 150 make API calls via API gateway 108, e.g., to report operational statuses of cloud service agents 150, also referred to as “heartbeats,” and to report results of operations performed by the management software of SDDCs 122.

Identity agent 152 is deployed on agent platform appliance 140 to acquire access tokens from cloud authentication service 112. Identity agent 152, when deployed, is given access to a private key of the tenant and transmits a challenge phrase that is signed with the private key as payload for authenticating with cloud authentication service 112. In response, cloud authentication service 112 decrypts the payload using a public key of the tenant and issues an access token for the tenant if the decrypted payload matches the challenge phrase. The access token enables one of cloud service agents 150, host server log agents 170, or agent platform log agents 190 to authenticate with cloud platform 104.

Discovery agents 154 are deployed on agent platform appliance 140 to manage communication with the management software of SDDCs 122. Each of discovery agents 154 corresponds to one type of management software for all of SDDCs 122. For example, one discovery agent is deployed for VIM server appliances 124 of all of SDDCs 122, and other discovery agents are deployed respectively for other SDDC components 128 of all of SDDCs 122. Each of discovery agents 154 is also configured to acquire access tokens from cloud authentication service 112 in the same manner as identity agent 170. Discovery agents 154 acquire access tokens to enable cloud service agents 150 to report results of operations to cloud services 106 and to enable SDDC component log agents 180 to authenticate with cloud platform 104. Each of discovery agents 154 also communicates with its respective SDDC components, such as VIM server appliance 124, to acquire authentication tokens. To enable this, each of discovery agents 154 maintains a set of privilege mappings (not shown), the privilege mappings indicating which “roles” agents deployed on agent platform appliance 140, are authorized for, and what privileges are associated with these roles.

Host server log agents 170 are deployed on agent platform appliance 140 to collect log data generated by host servers 130 of SDDCs 122. Each of host server log agents 170 corresponds to all of host servers 130 for one of SDDCs 122. SDDC component log agents 180 are deployed on agent platform appliance 140 to collect log data generated by the components of SDDCs 122. Each of SDDC component log agents 180 corresponds to one SDDC component for one of SDDCs 122, e.g., a single instance of VIM server appliance 124. Agent platform log agent 190 is deployed on agent platform appliance 140 to collect log data generated by other agents deployed on agent platform appliance 140, including cloud service agents 150, identity agent 152, discovery agents 154, and coordinator agent 156. Agent platform log agent 190 also collects log data generated by system processes 160 running on agent platform appliance 140 such as a secure shell daemon (sshd) system process and a system log process. Host server log agents 170, SDDC component log agents 180, and agent platform log agent 190 are collectively referred to herein as “log agents.”

Each of host server log agents 170 stores respective log data in a cache 172, each of SDDC component log agents 180 stores respective log data in a cache 182, and agent platform log agent 190 stores respective log data in a cache 192. The log agents maintain caches in order to transmit log data to cloud platform 104 in “batches.” For example, the log agents may periodically transmit respective log data when the respective caches are filled to predetermined amounts of log data. Furthermore, the log agents embed respective log data with metadata indicating the sources of the log data.

In one embodiment, each of the services of cloud platform 104 is a microservice that is implemented as one or more container images executing on a virtual infrastructure of public cloud 102. Similarly, each of the agents deployed on agent platform appliance 140 is a microservice that is implemented as one or more container images executing in agent platform appliance 140.

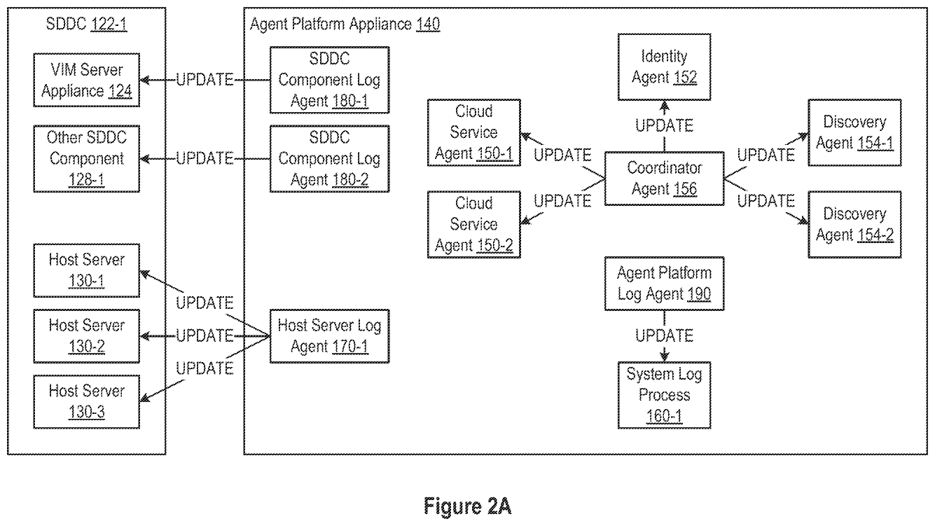

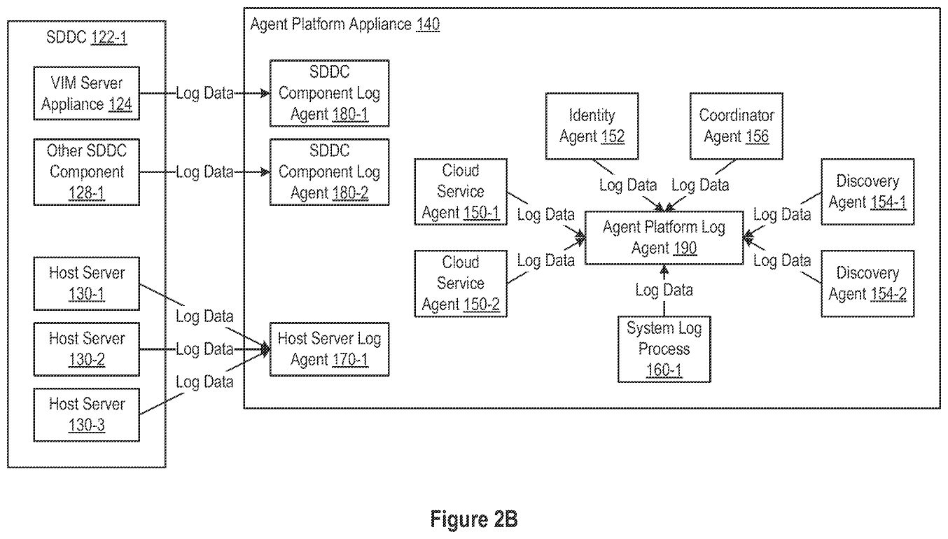

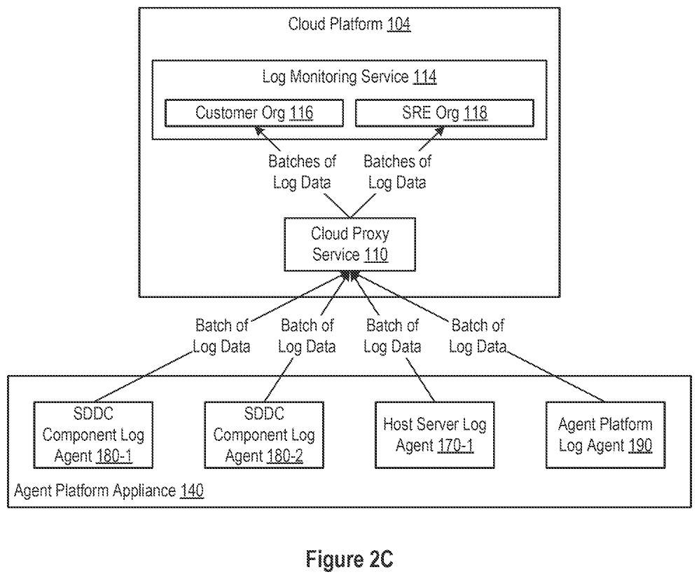

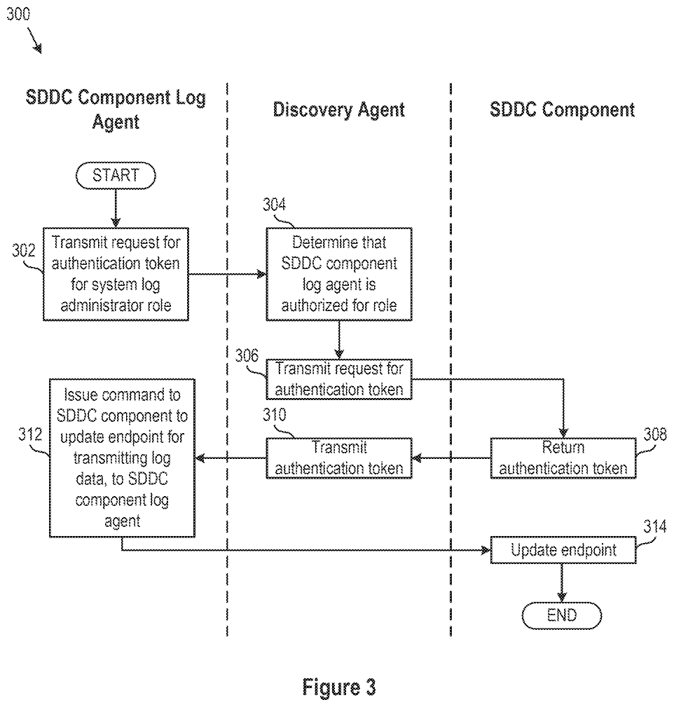

FIG. 2A is a system diagram illustrating the updating of endpoints of host servers and components of one of SDDCs 122 and of agents and a system log process 160-1 of agent platform appliance 140, for transmitting log data to, according to the first embodiment. As illustrated, an SDDC component log agent 180-1 corresponding to VIM server appliance 124 of an SDDC 122-1, transmits instructions to VIM server appliance 124 to update an endpoint thereof for transmitting log data, to SDDC component log agent 180-1. Similarly, an SDDC component log agent 180-2 transmits instructions to another SDDC component 128-1 to update an endpoint thereof for transmitting log data, to SDDC component log agent 180-2. VIM server appliance 124 and other SDDC component 128-1 update the endpoints thereof accordingly, e.g., to internet protocol (IP) addresses of SDDC component log agents 180-1 and 180-2, respectively. The updating of endpoints of SDDC components according to the first embodiment is discussed further below in conjunction with FIG. 3.

A host server log agent 170-1 transmits instructions to host servers 130-1, 130-2, and 130-3 of SDDC 122-1 to update endpoints thereof for transmitting log data, to host server log agent 170-1. Host servers 130-1, 130-2, and 130-3 update the endpoints thereof accordingly e.g., to an IP address of host server log agent 170-1. Coordinator agent 156 transmits instructions to cloud service agents 150-1 and 150-2, identity agent 152, and discovery agents 154-1 and 154-2 to update endpoints thereof for transmitting log data, to agent platform log agent 190. Cloud service agents 150-1 and 150-2, identity agent 152, and discovery agents 154-1 and 154-2 update the endpoints thereof accordingly, e.g., to an IP address of agent platform log agent 190. Agent platform log agent 190 transmits instructions to system log process 160-1 to update an endpoint thereof for transmitting log data, to agent platform log agent 190. System log process 160-1 updates the endpoint thereof accordingly, e.g., to the IP address of agent platform log agent 190. System log process 160-1 is discussed further below in conjunction with FIG. 2B.

FIG. 2B is a system diagram illustrating the collecting of log data from host servers and components of SDDC 122-1 and from agents and system process 160-1 of agent platform appliance 140, according to the first embodiment. As illustrated, after the updating of endpoints thereof, VIM server appliance 124 and other SDDC component 128-1 begin transmitting log data to SDC component log agents 180-1 and 180-2, respectively, which are stored in caches thereof. Similarly, after the updating of endpoints thereof, host servers 130-1, 130-2, and 130-3 begin transmitting log data to host server log agent 170-1, which are stored in a cache thereof. For example, VIM server appliance 124, other SDDC component 128-1, and host servers 130-1, 130-2, and 130-3 may periodically check predetermined locations therein for new log data to transmit, e.g., every thirty seconds, and transmit new log data when it is found.

Furthermore, after the updating of endpoints thereof, cloud service agents 150-1 and 150-2, identity agent 152, discovery agents 154-1 and 154-2, and system log process 160-1 begin transmitting log data to agent platform log agent 190, which are stored in cache 192. Coordinator agent 156 also transmits log data thereof to agent platform log agent 190 to be stored in cache 192. For example, if the agents deployed on agent platform appliance 140 are Docker® containers, native Docker® logging drivers retrieve the log data for respective agents and transmit the log data to agent platform log agent 190. System log process 160-1 is one of system processes 160. System log process 160-1 retrieves log data corresponding to other of system processes 160 running on agent platform appliance 140 such as the sshd process, and system log process 160-1 transmits the log data to agent platform log agent 190. The agents and system log process 160-1 may periodically retrieve log data to transmit, e.g., every thirty seconds.

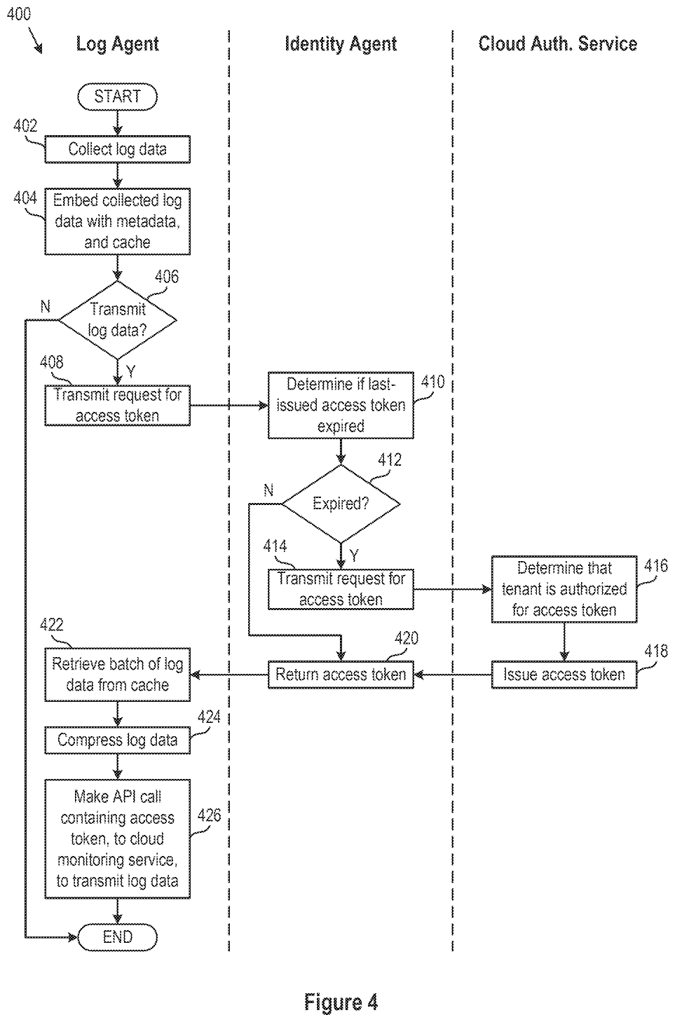

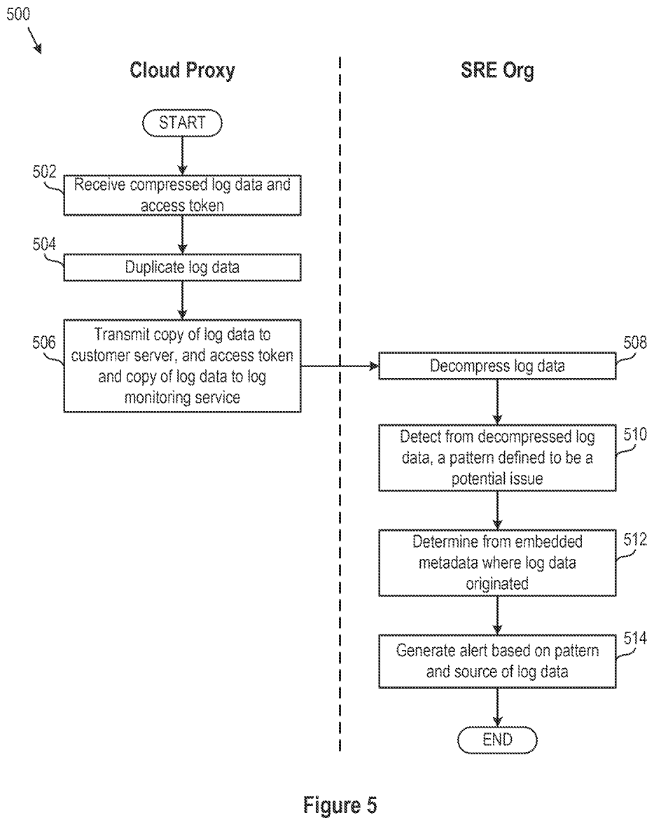

FIG. 2C is a system diagram illustrating the transmitting of log data to log monitoring service 114, according to the first embodiment. As illustrated, the log agents each transmit batches of respective log data that was collected and cached. Upon receiving a batch of log data, cloud proxy service 110 duplicates the batch of log data, transmitting one copy to customer organization 116 and another copy to SRE organization 118. The transmitting of log data to log monitoring service 114 via cloud proxy service 110 according to the first embodiment is discussed further below in conjunction with FIGS. 4 and 5.

FIG. 3 is a flow diagram of steps performed by one of SDDC component log agents 180, a corresponding one of discovery agents 154, and a corresponding SDDC component to carry out a method 300 of updating an endpoint of the SDDC component, according to the first embodiment. Method 300 is performed by each of SDDC component log agents 180 upon SDDC component log agents 180 being deployed on agent platform appliance 140 by coordinator agent 156. For example, method 300 will be discussed with respect to VIM server appliance 124 of one of SDDCs 122, and thus the one of SDDC component log agents 180 corresponding to VIM server appliance 124 for the one of SDDCs 122, and the one of discovery agents 154 corresponding to VIM server appliance 124 for all of SDDCs 122.

At step 302, SDDC component log agent 180 transmits a request to discovery agent 154 for an authentication token for a “system log administrator” role. The system log administrator role is associated with the privilege to update the endpoints for an SDDC component, for transmitting log data to. At step 304, discovery agent 154 checks a set of privilege mappings therein to determine that SDDC component log agent 180 is authorized for the system log administrator role. At step 306, discovery agent 154 transmits a request to VIM server appliance 124 for an authentication token that is scoped to the system log administrator role. At step 308, authentication module 126 of VIM server appliance 124 returns the requested authentication token to discovery agent 154. At step 310, discovery agent 154 transmits the authentication token to SDDC component log agent 180.

At step 312, SDDC component log agent 180 accesses VIM server appliance 124 using the authentication token acquired from discovery agent 154, to issue a command to update the endpoint of server appliance 124, for transmitting log data, to SDDC component log agent 180. At step 314, upon verifying that the request is within the scope of the authentication token transmitted by SDDC component log agent 312, VIM server appliance 124 performs the requested access by updating the endpoint thereof accordingly. After step 314, method 300 ends, and VIM server appliance 124 begins periodically transmitting log data to SDDC component log agent 180.

FIG. 4 is a flow diagram of steps performed by one of the log agents, identity agent 152, and cloud authentication service 112 to carry out a method 400 of transmitting log data to cloud proxy service 110, according to the first embodiment. At step 402, the log agent collects log data. For example, if the log agent is agent platform log agent 190, one of the other agents deployed on agent platform appliance 140 or system log process 160-1 transmits log data to agent platform log agent 190. At step 404, the log agent embeds the collected log data with metadata indicating the source and caches the log data in its respective cache. The log agent determines the source of the log data from a tag in the log data. For example, if the log agent is agent platform log agent 190 and the source of the metadata is the sshd system process, agent platform log agent 190 locates a tag in the log data such as “TAG=sshd,” and based on the tag, agent platform log agent 190 embeds metadata indicating that the source of the log data is the sshd system process of agent platform appliance 140.

At step 406, the log agent determines whether to transmit log data to cloud proxy service 110, by checking its respective cache to determine whether the cache is filled to a predetermined amount of log data. If the cache is not filled to the predetermined amount of log data, method 400 ends. Otherwise, if the cache is filled to the predetermined amount of log data, method 400 moves to step 408, and the log agent transmits a request to identity agent 152 for an access token for authenticating with log monitoring service 114. At step 410, identity agent 152 determines if the last access token (if any) acquired by identity agent 152 has expired, i.e., if the TTL thereof has lapsed. For example, identity agent 152 may compare a timestamp of the last access token to the current time to determine if the TTL of the access token has lapsed. At step 412, if the last-issued access token is still active, method 400 moves to step 420. Otherwise, if the last-issued access token has expired (or if identity agent 152 has not yet acquired an access token), method 400 moves to step 414.

At step 414, identity agent 152 transmits a request to cloud authentication service 112 for a new access token, the request including a payload containing the challenge phrase that is digitally signed using the private key of the tenant, as described above. At step 416, cloud authentication service 112 determines that the tenant is authorized for an access token by decrypting the payload in the request, using the public key of the tenant, and confirming the challenge phrase in the manner described above. At step 418, cloud authentication service 112 issues a new access token to identity agent 152. At step 420, identity agent 152 returns an access token to the log agent, the access token being either a previously issued access token determined to be active at step 412 or an access token issued at step 418.

At step 422, the log agent retrieves all the log data from its respective cache as a batch. At step 424, the log agent compresses the batch of log data according to a predetermined compression algorithm. At step 426, the log agent makes an API call containing the access token via API gateway 108, to transmit the compressed batch of log data to cloud proxy service 110. After step 426, method 400 ends. As previously mentioned, discovery agents 180 are configured to acquire access tokens for SDDC component log agents 180. Accordingly, steps of method 400 performed by identity agent 152 may alternatively be performed by discovery agent 180 when the log agent is one of SDDC component log agents 180.

FIG. 5 is a flow diagram of steps performed by cloud proxy service 110 and SRE organization 118 of log monitoring service 114 to carry out a method 500 of generating an alert regarding the operation of host servers 130, an SDDC component, an agent, or one of system processes 160, according to embodiments. At step 502, cloud proxy service 110 receives compressed log data from one of the log agents along with an access token. At step 504, cloud proxy service 110 duplicates the compressed log data.

At step 506, cloud proxy service 110 transmits a copy of the compressed log data to customer organization 116 to be decompressed and viewed by the tenant. Cloud proxy service 110 also transmits the access token and a copy of the compressed log data to SRE organization 118. At step 508, upon verifying the access token, SRE organization 118 decompresses the log data. At step 510. SRE organization 118 detects from the decompressed log data a pattern that is defined to be a potential issue. For example, the SRE using SRE organization 118 may have created such a definition.

At step 512, SRE organization 118 determines the source of the log data from metadata embedded with the log data. For example, the metadata may include an identifier of one SDDCs 122 or agent platform appliance 140 and an identifier of one of host servers 130, SDDC components, agents, or system processes 160. At step 514, SRE organization 118 generates an alert that includes both the pattern detected at step 510 and the source of the log data determined at step 512. After step 514, method 500 ends. Based on the alert generated by SRE organization 118, one of cloud services 106 may transmit a remediation action to agent platform appliance 140, e.g., if instructed by the SRE. Then, for example, if the determined source is one of host servers 130 or an SDDC component, the remediation command is forwarded by one of cloud service agents 150 along with an authentication token acquired from one of discovery agents 154, to one of SDDCs 122 to be applied. Otherwise, the remediation command is applied to the source of the log data within agent platform appliance 140.

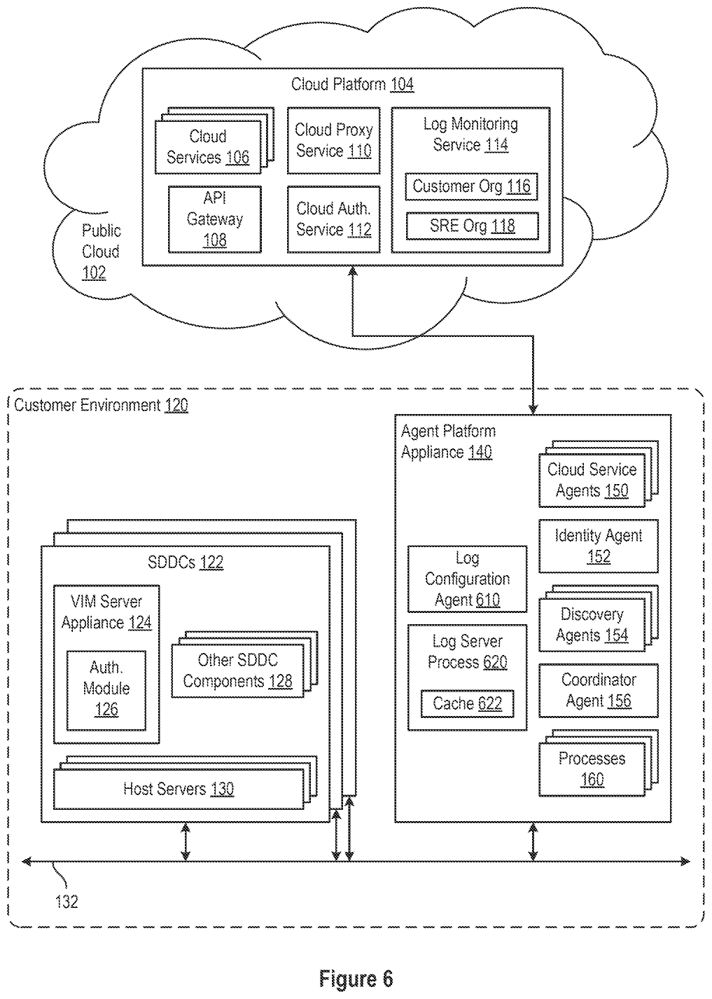

FIG. 6 is a block diagram of a computer system in which a second embodiment may be implemented. According the second embodiment, instead of including host server log agents 170, SDDC component log agents 180, and agent platform log agent 190, agent platform appliance 140 includes a single log configuration agent 610 deployed by coordinator agent 156 and a single log server process 620. Log configuration agent 610 updates endpoints of entities in SDDCs 122 and agent platform appliance 140, to transmit log data to log server process 620. Log configuration agent 610 also acquires access tokens for log server process 620, acquiring a new access token each time the TTL of a previously acquired access token lapses. Log server process 620 collects log data to store in a cache 622 and transmits batches of log data to cloud proxy service 110.

The second embodiment illustrated in FIG. 6 offers various advantages over the first embodiment illustrated in FIG. 1. Firstly, the second embodiment is more scalable because as the number of SDDCs 122, host servers 130, and SDDC components increases, the first embodiment involves the deployment of increasing numbers of host server log agents 170 and SDDC component log agents 180. On the other hand, the second embodiment still only includes log server process 620 to collect log data, which is less memory-intensive. Secondly, log server process 620 can run on agent platform appliance 140 before coordinator agent 156 deploys the other agents, including the log agents of the first embodiment. Accordingly, unlike the log agents of the first embodiment, log server process 620 can begin collecting log data generated by system processes 160 (from system log process 160-1) before the deployment of agents.

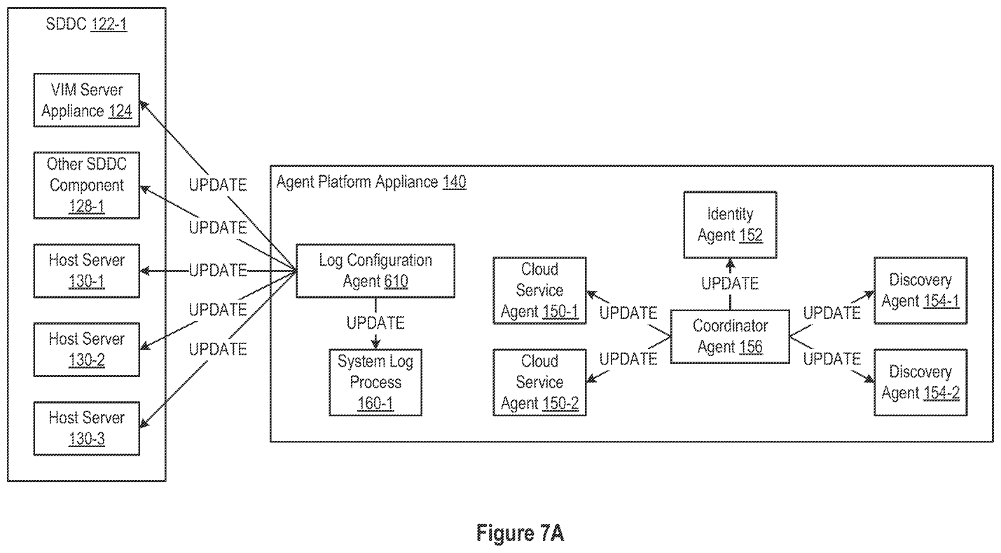

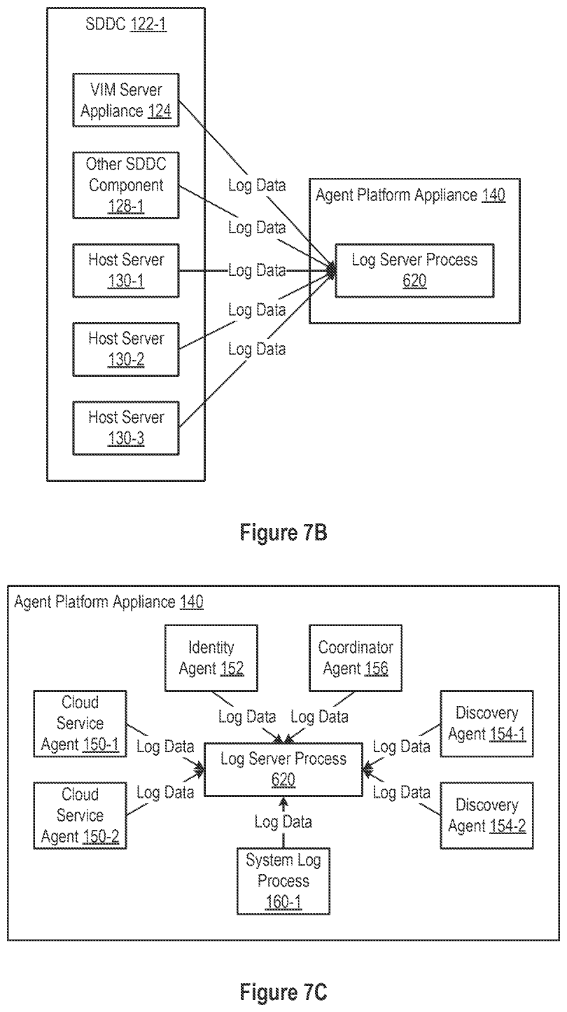

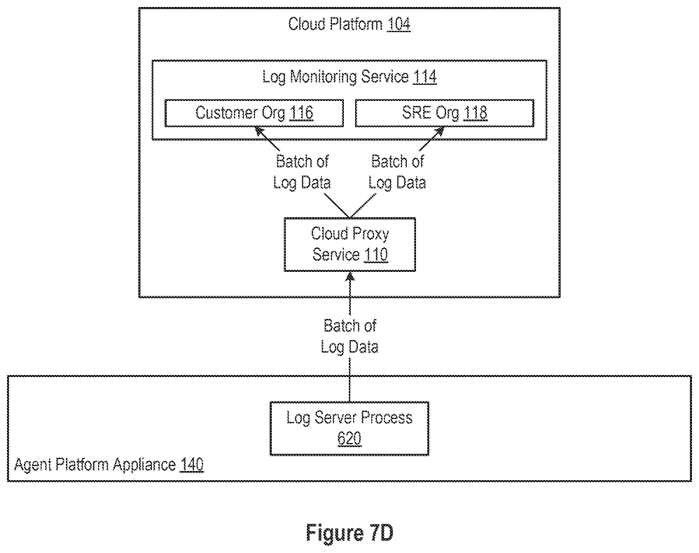

FIG. 7A is a system diagram illustrating the updating of endpoints of host servers and components of SDDC 122-1 and of agents and system log process 160-1 of agent platform appliance 140, for transmitting log data, according to the second embodiment. As illustrated, log configuration agent 610 transmits instructions to VIM server appliance 124 and other SDDC component 128-1 to update endpoints thereof for transmitting log data, to log server process 620. VIM server appliance 124 and other SDDC component 128-1 update the endpoints thereof accordingly, e.g., to an IP address of log server process 620. The updating of endpoints of SDDC components according to the second embodiment is similar to that of the first embodiment, which is discussed above in conjunction with FIG. 3. However, steps performed by one of SDDC component log agents 180 are instead performed by log configuration agent 610. Log configuration agent 610 also transmits instructions to host servers 130-1, 130-2, and 130-3 to update endpoints thereof for transmitting log data, to log server process 620. Host servers 130-1, 130-2, and 130-3 update the endpoints thereof accordingly e.g., to the IP address of log server process 620.

Log configuration agent 610 also transmits instructions to system log process 160-1 to update an endpoint thereof for transmitting log data, to log server process 620. System log process 160-1 updates the endpoint thereof accordingly, e.g., to the IP address of log server process 620. Coordinator agent 156 transmits instructions to cloud service agents 150-1 and 150-2, identity agent 152, and discovery agents 154-1 and 154-2 to update endpoints thereof for transmitting log data, to log server process 620. (loud service agents 150-1 and 150-2, identity agent 152, and discovery agents 154-1 and 154-2 update the endpoints thereof accordingly, e.g., to the IP address of log server process 620.

FIG. 7B is a system diagram illustrating the collecting of log data from host servers and components of SDDC 122-1, according to the second embodiment. As illustrated, after the updating of endpoints thereof, VIM server appliance 124 and other SDDC component 128-1 begin transmitting log data to log server process 620, which are stored in cache 622. Similarly, after the updating of endpoints thereof, host servers 130-1, 130-2, and 130-3 begin transmitting log data to log server process 620, which are also stored in cache 622. For example, VIM server appliance 124, other SDDC component 128-1, and host servers 130-1, 130-2, and 130-3 may periodically check predetermined locations therein for new log data to transmit, e.g., every thirty seconds, and transmit new log data when it is found.

FIG. 7C is a system diagram illustrating the collecting of log data from agents and system log process 160-1, according to the second embodiment. As illustrated, after the updating of endpoints thereof, cloud service agents 150-1 and 150-2, identity agent 152, discovery agents 154-1 and 154-2, and system log process 160-1 begin transmitting log data to log server process 620, which are stored in cache 622. Coordinator agent 156 also transmits log data to log server process 620 to be stored in cache 622. For example, if the agents deployed on agent platform appliance 140 are Docker® containers, native Docker® logging drivers retrieve the log data for respective agents and transmit the log data to log server process 620. System log process 160-1 retrieves log data corresponding to other of system processes 160 running on agent platform appliance 140 such as the sshd process, and system log process 160-1 transmits the log data to log server process 620. The agents and system log process 160-1 may periodically retrieve log data to transmit, e.g., every thirty seconds.

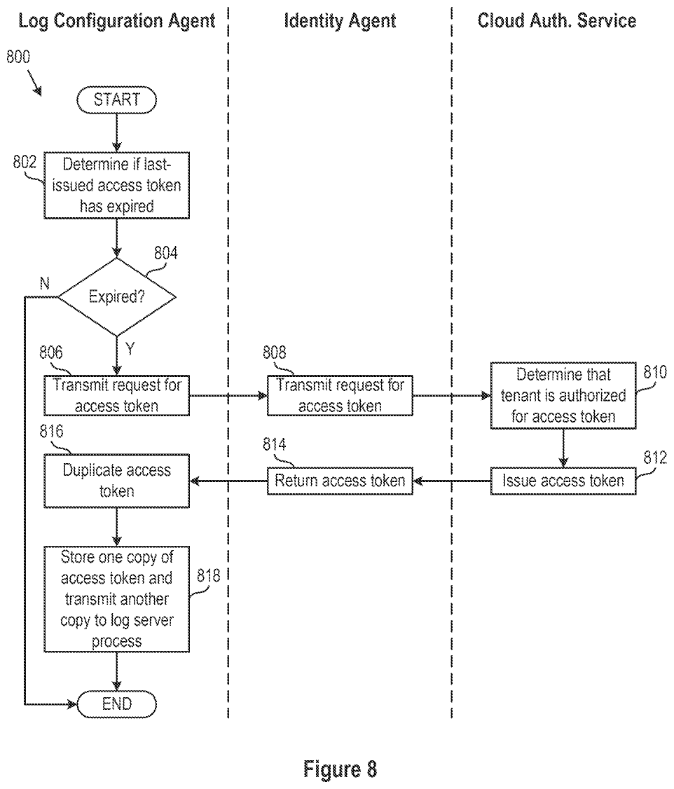

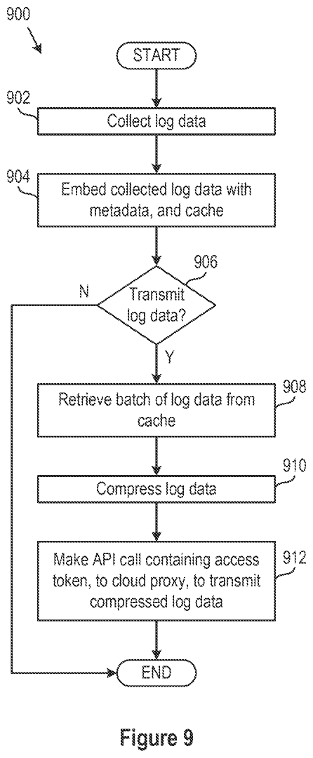

FIG. 7D is a system diagram illustrating the transmitting of log data to log monitoring service 114, according to the second embodiment. As illustrated, log server process 620 transmits batches of log data collected from SDDC components, host servers 130, agents, and system log process 160-1. Upon receiving a batch of log data, cloud proxy service 110 duplicates the batch of log data, transmitting one copy to customer organization 116 and another copy to SRE organization 118. The transmitting of log data to log monitoring service 114 via cloud proxy service 110 according to the second embodiment is discussed further below in conjunction with FIGS. 8 and 9.

FIG. 8 is a flow diagram of steps performed by log configuration agent 610, identity agent 152, and cloud authentication service 112 to carry out a method 800 of acquiring an access token for authenticating with log monitoring service 114, according to the second embodiment. At step 802, log configuration agent 610 determines if the last access token (if any) acquired from identity agent 152 has expired. As discussed further below, when log configuration agent 610 acquires an access token from identity agent 152, log configuration agent 610 stores a copy of the access token and transmits another copy to log server process 620 to be stored thereby. Log configuration agent 610 thus checks if its own copy of the access token has expired, e.g., by comparing a timestamp of the access token to the current time to determine if the TTL of the access token has lapsed.

At step 804, if the last-issued access token is still active, method 800 ends. Otherwise, if the last-issued access token has expired (or if log configuration agent 610 has not yet acquired an access token), method 800 moves to step 806, and log configuration agent 610 transmits a request to identity agent 152 for an access token for authenticating with log monitoring service 114. At step 808, identity agent 152 transmits a request to cloud authentication service 112 for a new access token, the request including a payload containing the challenge phrase that is digitally signed using the private key of the tenant, as described above.

At step 810 cloud authentication service 112 determines that the tenant is authorized for an access token by decrypting the payload in the request using the public key of the tenant and confirming the challenge phrase in the manner described above. At step 812, cloud authentication service 112 issues a new access token to identity agent 152. At step 814, identity agent 152 returns the new access token to log configuration agent 610. At step 816, log configuration agent 610 duplicates the new access token. At step 818, log configuration agent 610 stores one copy of the access token and transmits another copy of the access token to log server process 620, After step 818, method 800 ends.

FIG. 9 is a flow diagram of steps performed by log server process 620 to carry out a method 900 of transmitting log data to cloud proxy service 110, according to the second embodiment. At step 902, log server process 620 collects log data transmitted by one of the agents deployed on agent platform appliance 140, system log process 160-1, one of host servers 130, or an SDDC component. At step 904, log server process 620 embeds the collected log data with metadata and stores the log data in cache 622, the metadata identifying the one of the agents deployed on agent platform appliance 140, one of system processes 160, the one of host servers 130, or the SDDC component.

At step 906, log server process 620 determines whether to transmit log data to cloud proxy service 110, e.g., by checking cache 622 to determine whether cache 622 is filled to a predetermined amount of log data. If cache 622 is not filled to the predetermined amount of log data, method 900 ends. Otherwise, if cache 622 is filled to the predetermined amount of log data, method 900 moves to step 908, and log server process 620 retrieves all the log data from cache 622 as a batch. At step 910, log server process 620 compresses the batch of log data according to a predetermined compression algorithm. At step 912, log server process 620 makes an API call containing the access token via API gateway 108, to transmit the compressed batch of log data to cloud proxy service 110. After step 912, method 900 ends. Thereafter, in the manner described above in conjunction with FIG. 5, cloud proxy service 110 duplicates and transmits the log data to customer organization 116 and SRE organization 118, and if there is a pattern therein defined to be a potential issue, SRE organization 118 generates an alert.

The embodiments described herein may employ various computer-implemented operations involving data stored in computer systems. For example, these operations may require physical manipulation of physical quantities. Usually, though not necessarily, these quantities are electrical or magnetic signals that can be stored, transferred, combined, compared, or otherwise manipulated. Such manipulations are often referred to in terms such as producing, identifying, determining, or comparing. Any operations described herein that form part of one or more embodiments may be useful machine operations.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations. The embodiments described herein may also be practiced with computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer-readable media. The term computer-readable medium refers to any data storage device that can store data that can thereafter be input into a computer system. Computer-readable media may be based on any existing or subsequently developed technology that embodies computer programs in a manner that enables a computer to read the programs. Examples of computer-readable media are hard disk drives (HDDs), SSDs, network-attached storage (NAS) systems, read-only memory (ROM), RAM, compact disks (CDs), digital versatile disks (DVDs), magnetic tapes, and other optical and non-optical data storage devices. A computer-readable medium can also be distributed over a network-coupled computer system so that computer-readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and steps do not imply any particular order of operation unless explicitly stated in the claims.

Virtualized systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data. Many variations, additions, and improvements are possible, regardless of the degree of virtualization. The virtualization software can therefore include components of a host, console, or guest operating system (OS) that perform virtualization functions.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined component. Similarly, structures and functionalities presented as a single component may be implemented as separate components. These and other variations, additions, and improvements may fall within the scope of the appended claims.

What is claimed is:

1. A method of forwarding logs of a software-defined data center (SDDC) and logs of an agent platform appliance to a cloud platform through the agent platform appliance, the agent platform appliance having deployed thereon a plurality of agents of cloud services that are delivered to the SDDC, the method comprising:
collecting first log data from one or more management appliances of the SDDC;
collecting second log data from one or more of the agents of cloud services;
acquiring one or more access tokens for communicating with the cloud platform; and
transmitting log data generated from the collected first log data and the collected second log data, along with the one or more access tokens, to a log monitoring service running in the cloud platform, wherein the cloud platform is a multi-tenant cloud platform, and the log monitoring service is configured to generate alerts separately for each of different tenants of the computer system from log data of the different tenants that is forwarded to the log monitoring service and that originates from SDDCs and agent platform appliances of the different tenants.

2. The method of claim 1, further comprising:
acquiring an authentication token to authenticate with a management appliance of the SDDC; and
transmitting the authentication token to the management appliance of the SDDC along with an instruction to update an endpoint of the management appliance for transmitting log data of the management appliance to.

3. The method of claim 1, further comprising:
before the transmitting of the generated log data to the log monitoring service, embedding the collected first log data with metadata that identifies the one or more management appliances as having generated the first log data.

4. The method of claim 1, wherein the one or more management appliances of the SDDC includes a first management appliance and a second management appliance, and the first log data includes a first portion collected from the first management appliance and a second portion collected from the second management appliance.

5. The method of claim 4, wherein the first portion of the first log data is collected by a first agent deployed on the agent platform appliance, and the second portion of the first log data is collected by a second agent deployed on the agent platform appliance.

6. The method of claim 4, wherein the first and second portions of the first log data are collected by a first system process running on the agent platform appliance, the method further comprising:
caching, by the first system process, the first log data and the second log data; and
compressing, by the first system process, the first log data together with the second log data, wherein the transmitting of the generated log data to the log monitoring service includes transmitting, by the first system process, the compressed first log data and second log data to the log monitoring service.

7. The method of claim 6, further comprising:
transmitting, by a log configuration agent deployed on the agent platform appliance, instructions to the first and second management appliances to update endpoints thereof for transmitting respective log data, to the first system process.

8. The method of claim 7, further comprising:
collecting, by the first system process, third log data from a second system process running on the agent platform appliance;
collecting, by the first system process, fourth log data from one or more host servers of the SDDC;
caching, by the first system process, the third log data and the fourth log data; and
compressing, by the first system process, the first log data together with the second log data, the third log data, and the fourth log data, wherein the transmitting of the generated log data to the log monitoring service includes transmitting, by the first system process, the compressed first log data, second log data, third log data, and fourth log data to the log monitoring service.

9. A non-transitory computer-readable medium comprising instructions that are executable in a computer system, wherein the instructions when executed cause the computer system to carry out a method of forwarding logs of a software-defined data center (SDDC) of the computer system and logs of an agent platform appliance of the computer system to a cloud platform of the computer system through the agent platform appliance, the agent platform appliance having deployed thereon a plurality of agents of cloud services that are delivered to the SDDC, the method comprising:
collecting first log data from one or more management appliances of the SDDC;
collecting second log data from one or more of the agents of cloud services;
acquiring one or more access tokens to communicate with the cloud platform; and
transmitting log data generated from the collected first log data and the collected second log data, along with the one or more access tokens, to a log monitoring service running in the cloud platform, wherein the cloud platform is a multi-tenant cloud platform, and the log monitoring service is configured to generate alerts separately for each of different tenants of the computer system from log data of the different tenants that is forwarded to the log monitoring service and that originates from SDDCs and agent platform appliances of the different tenants.

10. The non-transitory computer-readable medium of claim 9, the method further comprising:
acquiring an authentication token to authenticate with a management appliance of the SDDC; and
transmitting the authentication token to the management appliance of the SDDC along with an instruction to update an endpoint of the management appliance for transmitting log data of the management appliance to.

11. The non-transitory computer-readable medium of claim 9, the method further comprising:
before the transmitting of the generated log data to the log monitoring service, embedding the collected first log data with metadata that identifies the one or more management appliances as having generated the first log data.

12. The non-transitory computer-readable medium of claim 9, wherein the one or more management appliances of the SDDC includes a first management appliance and a second management appliance, and the first log data includes a first portion collected from the first management appliance and a second portion collected from the second management appliance.

13. The non-transitory computer-readable medium of claim 12, wherein the first portion of the first log data is collected by a first agent deployed on the agent platform appliance, and the second portion of the first log data is collected by a second agent deployed on the agent platform appliance.

14. The non-transitory computer-readable medium of claim 12, wherein the first and second portions of the first log data are collected by a system process running on the agent platform appliance, the method further comprising:
caching, by the system process, the first log data and the second log data; and
compressing, by the system process, the first log data together with the second log data, wherein the transmitting of the generated log data to the log monitoring service includes transmitting, by the system process, the compressed first log data and second log data to the log monitoring service.

15. A computer system comprising a plurality of servers, the plurality of servers including an agent platform appliance, a software-defined data center (SDDC), and a cloud platform, and the agent platform appliance including a plurality of agents deployed thereon, wherein the agent platform appliance is configured to:
collect first log data from one or more management appliances of the SDDC;
collect second log data from one or more of the agents of cloud services;
acquire one or more access tokens for communicating with the cloud platform; and
transmit log data generated from the collected first log data and the collected second log data, along with the one or more access tokens, to a log monitoring service running in the cloud platform, wherein the cloud platform is a multi-tenant cloud platform, and the log monitoring service is configured to generate alerts separately for each of different tenants of the computer system from log data of the different tenants that is forwarded to the log monitoring service and that originates from SDDCs and agent platform appliances of the different tenants.

16. The computer system of claim 15, wherein the one or more management appliances of the SDDC includes a first management appliance and a second management appliance, and the first log data includes a first portion collected from the first management appliance and a second portion collected from the second management appliance.

17. The computer system of claim 16, wherein the first portion of the first log data is collected by a first agent deployed on the agent platform appliance, and the second portion of the first log data is collected by a second agent deployed on the agent platform appliance.

18. The computer system of claim 16, wherein the first and second portions of the first log data are collected by a first system process running on the agent platform appliance, and the first system process is configured to:
cache the first log data and the second log data; and
compress the first log data together with the second log data, the transmitting of the generated log data to the log monitoring service including transmitting, by the first system process, the compressed first log data and second log data to the log monitoring service.

19. The computer system of claim 18, wherein a log configuration agent deployed on the agent platform appliance is configured to:
transmit instructions to the first and second management appliances to update endpoints thereof for transmitting respective log data, to the first system process.

20. The computer system of claim 19, wherein the first system process is further configured to:
collect third log data from a second system process running on the agent platform appliance;
collect fourth log data from one or more host servers of the SDDC;
cache the third log data and the fourth log data; and
compress the first log data together with the second log data, the third log data, and the fourth log data, wherein the transmitting of the generated log data to the log monitoring service includes transmitting, by the first system process, the compressed first log data, second log data, third log data, and fourth log data to the log monitoring service.
